(19) United States
(12) Patent Application Publication
(10) Pub. No.: US 2012/0139853 A1
(43) Pub. Date: Jun. 7, 2012

(54) Information Input Device and Information Input Method

(76) Inventor: Jun Kano, Ome-shi (JP)

(21) Appl. No.: 13/240,984

(22) Filed: Sep. 22, 2011

(30) Foreign Application Priority Data
Dec. 7, 2010 (JP) 2010-272873

(51) Int. Cl. G06F 3/041

(52) U.S. Cl. 345/173

(57) ABSTRACT

An information input device includes: a touch screen; a manipulation information acquiring module configured to extract a keyword from a text based on position information that is input to the touch screen externally; a storage module configured to store a preset keyword selection font size; and a picture generator configured to put the touch screen into a keyword selection state based on manipulation information that is input externally, and configured to perform a control in the keyword selection state so that a text is displayed on the touch screen with the keyword selection font size.

### CROSS REFERENCE TO RELATED APPLICATION(S)

The application is based upon and claims the benefit of priority from Japanese Patent Application No. 2010-272873 filed on Dec. 7, 2010, the entire contents of which are incorporated herein by reference.

### BACKGROUND

1. Field

The present invention relates to an information input device and an information input method which enable selection and input of a keyword or the like.

2. Description of the Related Art

In recent years, cell phones, TV remote controllers, etc. have been put on the market which are equipped with a touch screen as an input module. In these kinds of apparatus, characters are input using a virtual keyboard displayed on the screen, a hand-written character input module, or the like.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing the configuration of an information input device according to a first embodiment;

FIGS. 2A and 2B illustrate an example operation (picture enlargement) performed in the first embodiment;

FIG. 3 shows an example calibration picture used in the first embodiment;

FIG. 4 illustrates an example manipulation which is made after a keyword selection in the first embodiment; and

FIG. 5 is an example keyword selection accuracy management table used in the first embodiment.

### DETAILED DESCRIPTION

Embodiments of the present invention will be hereinafter described.

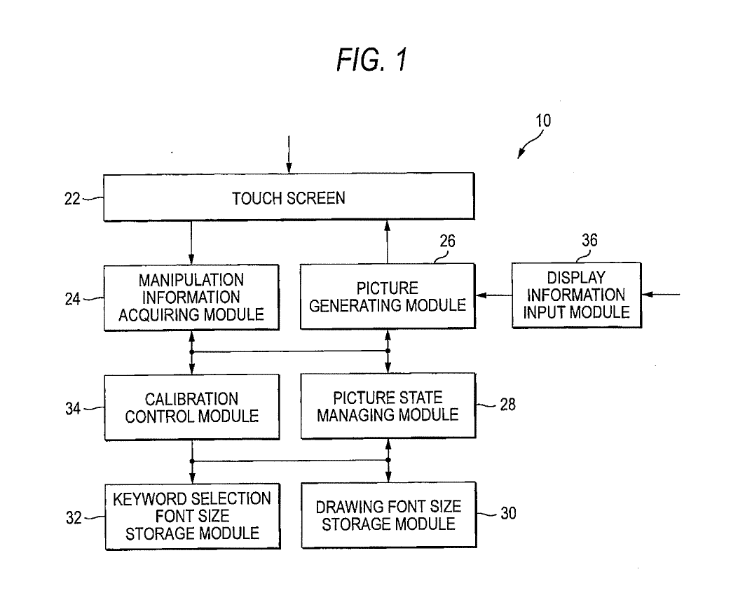

A first embodiment of the invention will be described below with reference to FIGS. 1-5.

FIG. 1 is a block diagram of an information input device 10 which enables selection of a keyword. As shown in FIG. 1, the information input device 10 is equipped with a touch screen 22, a manipulation information acquiring module 24, a picture generating module 26, a picture state managing module 28, a drawing font size storage module 30, a keyword selection font size storage module 32, a calibration control module 34, and a display information input module 36.

The touch screen 22 displays a picture to the user and accepts a direct input of the user. The manipulation information acquiring module 24 is configured to extract a keyword from a text based on position information corresponding to an external input to the touch screen. More specifically, the manipulation information acquiring module 24 recognizes a screen state and a selected portion on the screen on the basis of the received user input using sets of coordinates of displayed characters. The picture generating module 26 generates information to be displayed actually on the touch screen 22 on the basis of information supplied externally (e.g., over a network or a telephone line) and user manipulations. The picture state managing module 28 manages a state (e.g., for ordinary display or for keyword selection) of a currently displayed picture on the basis of information supplied from the manipulation information acquiring module 24. The drawing font size storage module 30 is stored with a font size of characters to be displayed usually on the screen when the user makes a manipulation.

The keyword selection font size storage module 32 is stored with a font size of characters to be displayed when the user has made the apparatus state a keyword selection state to select a keyword. The calibration control module 34 automatically calculates this keyword selection font size under prescribed rules.

The touch screen 22 also displays, through the picture generating module 26, text/image information such as a homepage (external information) that is downloaded from the Internet or the like by the display information input module 36.

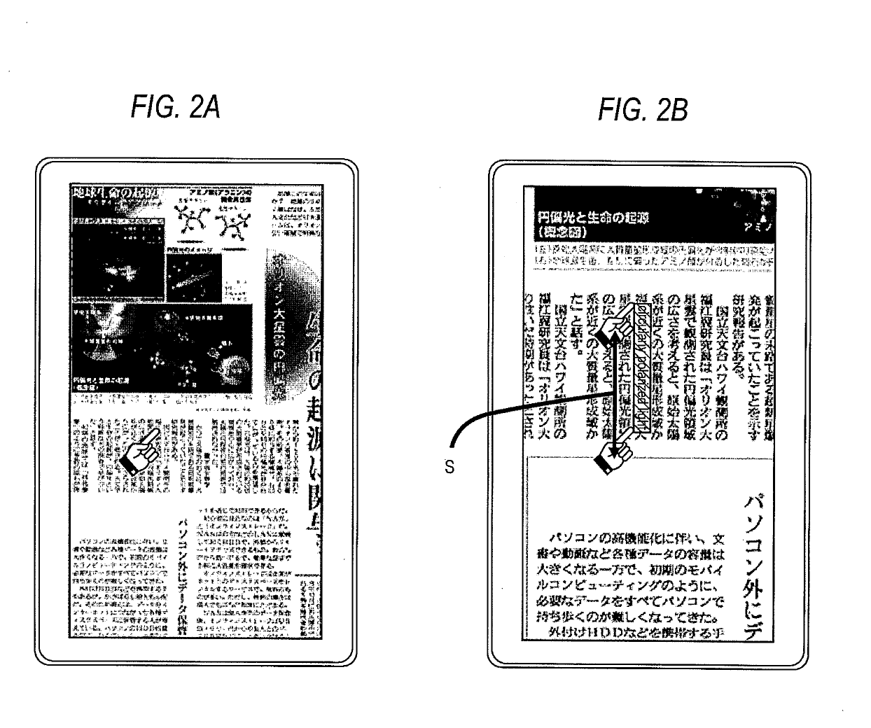

FIGS. 2A and 23 illustrate an example operation performed in the embodiment. When using the apparatus incorporating the information input device 10, usually the main purpose of the user is to “view” a picture. Therefore, usually, the user specifies a font size with which the user can easily recognize characters visually though it depends on the screen size. However, whereas the user can visually recognize characters having such a size, it is difficult for the user to actually discriminate a particular character string (keyword) from the other part of a text of those characters by a finger manipulation. The embodiment assumes the presence of a function of selecting character information necessary for a search, registration, or the like from a character string that is displayed on the screen. Therefore, for example, a font size for viewing causes problems that a head or tail character cannot be selected successfully and that a selection range extends to the next line contrary to the intention of the user. In view of this, in the embodiment, in an ordinary state that the user sees a picture, as shown in FIG. 2A the picture is displayed with a default font size for viewing. When the user has changed the state of the apparatus to a state for keyword selection, as shown in FIG. 2B the font size is changed automatically so as to be larger than or equal to a preset size with which the user can easily select a keyword (e.g., the user “rubs” a character string “circularly polarized light” as indicated by arrow S). How to cause a transition from the viewing state to the keyword selection state is not described in detail in the embodiment. For example, this is done by the user's selecting a change to either state through a menu or the like displayed on the screen or using an icon or the like displayed on the screen, pressing a particular physical button provided on the apparatus body, or performing a particular manipulation (e.g., writing a character “S” (stands for selection)) on the screen.

A keyword can be selected by, for example, specifying its start point and end point. The information input device 10 may be configured so that a keyword that bridges two lines in a horizontally written text is selected by drawing a bracket shape from a position close to the end of the first line to a position close to the end of the second line and specifying a position near the beginning of the second line. Alternatively, the information input device 10 may be configured so that a keyword can be selected by drawing an ellipse around the keyword.

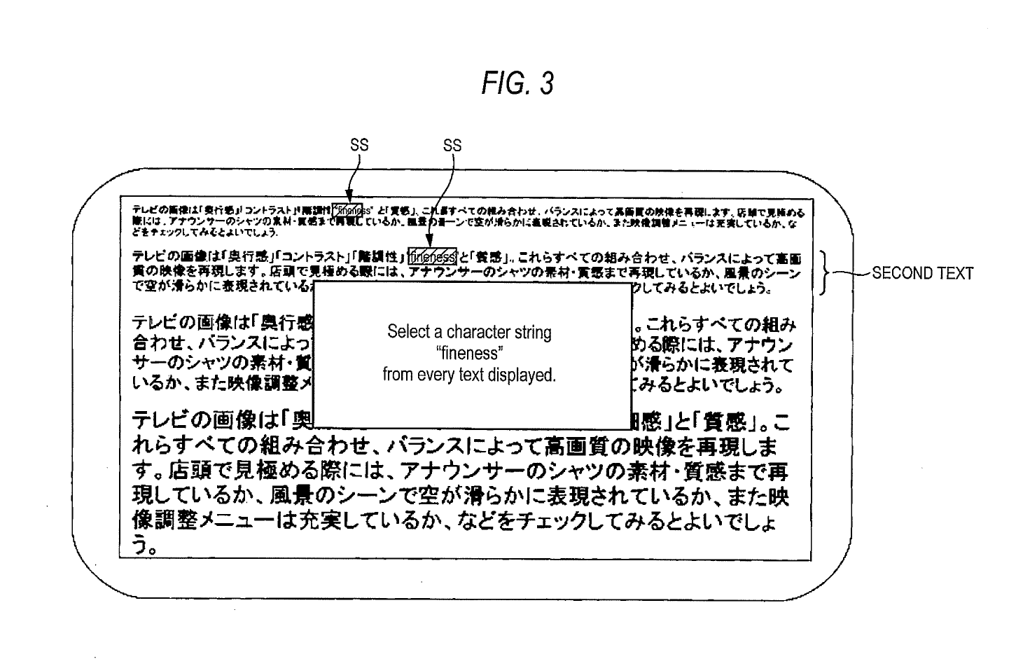

FIG. 3 shows an example calibration picture. As shown in FIG. 2, plural versions, having various font sizes, of a text are displayed to the user and the user is caused to select a particular character string from each version, whereby accuracy levels of selection of a character string for the respective font sizes are calculated. In this example, the user is caused to select a character string “fineness” indicated by symbol SS. In the case of the top-most text version having the smallest font size, neither the head character nor the tail character is specified successfully. In the case of the second text version, both of the head character and the tail character are specified successfully, that is, the keyword is selected by the user without causing any problem. Therefore, with an understanding that for this user keywords can be selected with a certain level of accuracy by using the font size of the second text version, this font size is stored as a keyword selection font size. Although in this example the user is caused to select the common character string “fineness,” the user may be caused to select different character strings for respective font sizes. Although in this example the text versions having all the font sizes are displayed in the same page, text versions having respective font sizes may be displayed in separate pages. To reduce time and labor to be taken by the user, it is not always necessary to have the user select character strings having all the font sizes. Furthermore, to increase the accuracy, the user may be caused to select, for each font size, character strings of plural patterns that vary in terms of the display position (e.g., a character string bridging two lines) and the font details (e.g., font attributes and types).

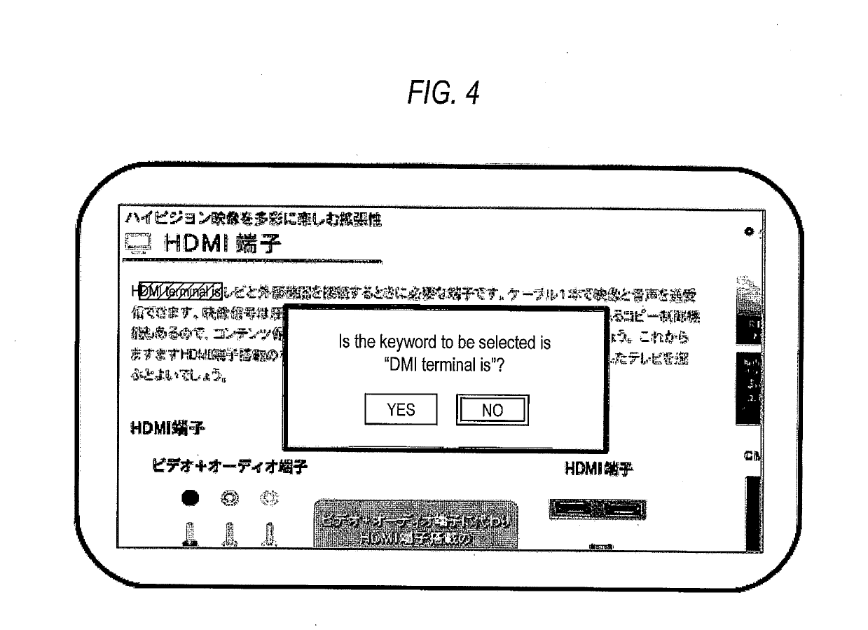

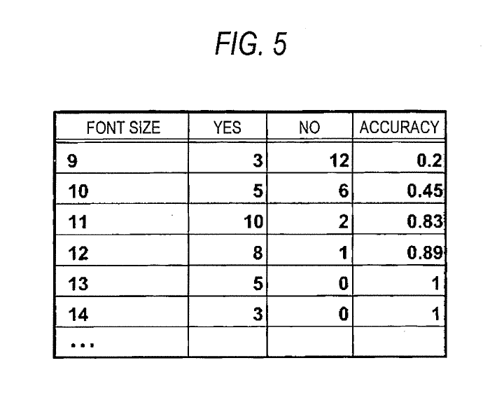

FIG. 4 shows an example of a function of calculating keyword selection accuracy levels by correlating font sizes with user manipulations made after keyword selections and determining, automatically, in the information input device 10, a font size that allows the user to select a keyword easily on the basis of the calculated selection accuracy levels. In this example, after selecting a character string (keyword), the user is asked whether or not a selected range is correct. In the example of FIG. 4, the user tried to select a word “HDMI terminal” but an erroneous selection range “DMI terminal is” was obtained. If the user selects “No” in a confirmation picture (in FIG. 4, “No” is enclosed by a double rectangle for convenience), the information input device 10 judges that a wrong keyword has been selected and that the current font size is associated with a problem of low selection accuracy. In this example, the user is requested to make a yes or no answer. Instead of making such a direct inquiry, each font size may be correlated with, for example, a manipulation “Return” or “Cancel” which is made after a keyword selection. In this manner, the user selection accuracy levels are updated by checking a selection result every time the user selects a keyword and a proper font size is determined on the basis of the selection accuracy levels thus obtained. FIG. 5 shows a specific manner of update of selection accuracy levels.

FIG. 5 is an example table which is used for managing relationships between user manipulations that were made in the manner shown in FIG. 4 and keyword selection accuracy levels. In the example of FIG. 4, after selecting a keyword, the user is asked whether or not the selected keyword is correct. The information input device 10 internally manages relationships between font sizes of text versions and yes/no results in the manner shown in FIG. 5. And font sizes each of which provides a “yes” probability that is higher than or equal to a prescribed value (e.g., 0.8) are judged to provide sufficient accuracy. When the user has changed the apparatus state to the keyword selection state, enlargement processing is performed automatically so that the smallest one (in the example of FIG. 5, the font size “11”) of the above font sizes is employed. The information input device 10 may be configured in such a manner that the user can set a value that is different from the value “0.8.” Furthermore, the information input device 10 may be configured in such a manner that the user can set an upper limit, a lower limit, etc. of font sizes according to his or her tastes etc. Although the example of FIG. 5 is so simple that “yes” probabilities are merely calculated, the manner of calculation of accuracy levels is not limited to this. For example, a normal distribution may be used. Although the example of FIG. 5 is so simple that selection accuracy levels are judged using only font sizes, the selection accuracy may also depend on the kind of font (e.g., font type). Therefore, a smallest font size may be determined for each kind of font.

The first embodiment assumes the use of the technique of selecting a keyword when a character string is traced. However, a technique is available which selects a keyword when a character string is merely touched instead of being traced. In this technique, a keyword is extracted automatically by performing a morphological analysis or the like. For example, a sentence is decomposed into words and a keyword is extracted on the basis of parts of speech of the words and relationships between each word and words adjacent to it.

Also in such a case, the problem that the selection accuracy depends on the font size would still remain and hence a technique similar to the technique of the first embodiment would be applicable. Furthermore, aside from the keyword selection, a similar problem arises when, for example, HTML links are located adjacent to each other. A technique similar to the technique of the first embodiment is applicable to such a case.

The above-described embodiments are characterized in that when characters are small, they are enlarged automatically to such a size that a character string can be selected easily.

To this end, a font size for keyword selection is stored in the information input device 10 separately from a font size for viewing. When a keyword is to be selected, a picture is enlarged so that a font size that is larger than or equal to the keyword selection font size is employed. Selection with a finger is prone to a phenomenon that the head or tail character of a character string to be selected is lost or an unnecessary character is added as a head or tail character. The probability of occurrence of such a selection error is lowered by specifying a keyword region by making a manipulation of reciprocating a finger plural times so as to “paint over” it and detecting densities in the manipulated region. For example, if 80% or more (density) of a character input region of 32×32 pixels has been touched cumulatively, this character input region is judged to be part of the traced region.

The calibration function is provided because it is difficult to have the user determine a font size. The calibration function automatically determines a font size suitable for the user on the basis of selection results.

According to the embodiment, in the keyword selection state, the information input device 10 automatically sets a font size with which the user can easily select a keyword. As a result, the probability of occurrence of a keyword selection error is lowered and it becomes possible to select a keyword efficiently from a text displayed on the screen. Furthermore, by virtue of the calibration function, the user need not set a font size by himself or herself. And the keyword selection efficiency is increased because a font size that would provide high selection accuracy in an objective sense can be used.

In summary, in an apparatus capable of keyword selection, when a user has traced, with his or her finger, a character string that the user wants to employ as a search keyword in a text displayed on a touch screen, the thus-selected keyword is registered. In a keyword selection state, the character font size is made larger than in an ordinary display state. The invention provides the following information input devices.

According to one embodiment of the invention, there is provided an information input device wherein a preset keyword selection font size is stored in advance, and wherein when a user has put an apparatus into a keyword selection state, a picture is enlarged automatically so that characters are displayed on the screen with a font size that is larger than or equal to the present keyword selection font size.

The information input device may have a function of automatically determining, within the information input device, a font size with which the user can select a keyword stably by having the user select a predetermined character string by tracing it from each of calibration texts (provided in the information input device) having respective font sizes and calculating selection accuracy levels corresponding to respective font sizes.

In the information input device, a character string that has been traced by a finger of the user as if a region of the character string is painted over may be extracted as a keyword from a text displayed on the touch screen.

In The information input device, a character string located in a region that has been traced at densities that are higher than or equal to a prescribed value may be extracted as a keyword.

The information input device may have a function of calculating the keyword selection accuracy levels by correlating the font sizes with manipulations made by the user after keyword selections and automatically determining, within the information input device, based on the calculated selection accuracy levels, a font size with which the user can easily select a keyword.

The invention is not limited to the above embodiments themselves, and may be practiced so as to be modified in various manners without departing from the spirit and scope of the invention.

Various inventions can be conceived by properly combining plural constituent elements disclosed in each embodiment. For example, several ones of the constituent elements of each embodiment may be omitted. In the mode of the above item (3), the calibration control module 34 may be omitted because the calibration function is not necessary.

Furthermore, constituent elements of different embodiments may be combined as appropriate.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information input device comprising:
a touch screen;
a manipulation information acquiring module configured to extract a keyword from a text based on position information corresponding to an external input to the touch screen;
a storage module configured to store a preset keyword selection font size; and
a picture generator configured to put the touch screen into a keyword selection state based on manipulation information that is input externally, and configured to perform a control in the keyword selection state so that a text is displayed on the touch screen with the keyword selection font size.

2. The information input device according to claim 1, further comprising
a calibrating module configured to determine the keyword selection font size based on keyword selection accuracy levels of a user corresponding to respective font sizes.

3. The information input device according to claim 1, wherein
the manipulation information acquiring module extracts from a text displayed on the touch screen as a keyword, a character string that has been traced by a finger of a user as if a region of the character string is painted over.

4. The information input device according to claim 3, wherein
the manipulation information acquiring module extracts a character string located in a region that has been traced at densities that are higher than or equal to a prescribed value as a keyword.

5. The information input device according to claim 2, wherein
the calibrating module calculates the keyword selection accuracy levels by correlating the font sizes with manipulations made by the user after keyword selections.

6. An information input method in an information input device having a touch screen, comprising:
storing a preset keyword selection font size;
putting the touch screen into a keyword selection state based on manipulation information that is input externally;
displaying a text on the touch screen with the keyword selection font size in the keyword selection state; and
extracting a keyword from the text based on position information corresponding to an external input to the touch screen.
